(19) United States
(12) Patent Application Publication
(10) Pub. No.: US 2011/0137959 A1
(43) Pub. Date: Jun. 9, 2011

(54) REPRESENTING RELATIONAL SCHEMA INFORMATION USING GENERIC META SCHEMAS

(75) Inventors: Clemens Kerer, Vienna (AT); Siddharth Jayadevan, Seattle, WA (US); Brad Mark Olenick, Redmond, WA (US); Gregory Lawrence Hughes, Redmond, WA (US)

(73) Assignee: MICROSOFT CORPORATION, Redmond, WA (US)

(21) Appl. No.: 12/632,613

(22) Filed: Dec. 7, 2009

(51) Int. Cl. G06F 7/00

(52) U.S. Cl. 707/812; 707/E17.045

(57) ABSTRACT

In an embodiment, a computer system defines a generic relational meta-schema (GRMS), where the GRMS describes a generic representation for relational schemas and where the GRMS includes metadata indicating how a relational schema is to be stored as data in the data store. The computer system also defines describes a generic relational data schema (GRDS), where the GRDS describes a generic representation for relational data and where the GRDS includes metadata that indicates how relational data is to be stored in the data store in a generic fashion not necessarily complying with the relational schema for the data. Next, the computer system stores data in the data store according to the generic relational data schema and stores metadata as data in the data store according to the generic relational meta-schema.

### BACKGROUND

Computers have become highly integrated in the workforce, in the home, in mobile devices, and many other places. Computers can process massive amounts of information quickly and efficiently. Software applications designed to run on computer systems allow users to perform a wide variety of functions including business applications, schoolwork, entertainment and more. Software applications are often designed to perform specific tasks, such as word processor applications for drafting documents, or email programs for sending, receiving and organizing email.

In some cases, software applications are designed to interact with or even design other software applications. For instance, integrated development environments (IDEs) may be used to write and debug software applications. Such applications may include various types of applications including data-centric applications. Data-centric applications are applications that provide access data (among other things) which is typically stored in a database. Data-centric application design typically includes designing a relational schema upon which the rest of the application is built. Requirements for the application, however, tend to change over time. These changes lead to further changes in the relational schema as well as data changes within the relational database.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Embodiments described herein are directed to designing a computer implemented application in conjunction with a data store used by the computer application and automatically evolving a generic relational data schema corresponding to a software application during development of the application. In one embodiment, a computer system defines a generic relational meta-schema (GRMS), where the GRMS describes a generic representation for relational schemas and where the GRMS includes metadata indicating how a relational schema is to be stored as data in the data store. The computer system also defines a generic relational data schema (GRDS), where the GRDS describes a generic representation for relational data and where the GRDS includes metadata that indicates how relational data is to be stored in the data store in a generic fashion not necessarily complying with the relational schema for the data. Next, the computer system stores data in the data store according to the generic relational data schema and stores metadata as data in the data store according to the generic relational meta-schema.

In another embodiment, a computer system instantiates a relational data abstraction layer that is configured to provide an interface to object-relational mappings (ORMs) in an ORM system that includes a data store, regardless of whether data is being retrieved from a real database or from other data sources that conform to a generic relational schema. The relational data abstraction layer is configured to hide the relational data's origin from the ORM system and support various connector components configured to load data from a variety of sources. The computer system receives a set of changes to metadata and accesses the received set of metadata changes, where the set of metadata changes indicates various data changes that are to be applied. The computer system also applies any data changes indicated by the set of metadata changes automatically without any user interaction or changes to the native schema of the data store.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a computer architecture in which embodiments of the present invention may operate including designing a computer implemented application and automatically evolving a generic relational data schema.

FIG. 2 illustrates a flowchart of an example method for designing a computer implemented application in conjunction with a data store used by the computer application.

FIG. 3 illustrates a flowchart of an example method for automatically evolving a generic relational data schema corresponding to a software application during development of the application.

FIG. 4 illustrates an embodiment of the present invention various elements interact with a relational data abstraction layer.

### DETAILED DESCRIPTION

Embodiments described herein are directed to designing a computer implemented application in conjunction with a data store used by the computer application and automatically evolving a generic relational data schema corresponding to a software application during development of the application. In one embodiment, a computer system defines a generic relational meta-schema (GRMS), where the GRMS describes a generic representation for relational schemas and where the GRMS includes metadata indicating how a relational schema is to be stored as data in the data store. The computer system also defines describes a generic relational data schema (GRDS), where the GRDS describes a generic representation for relational data and where the GRDS includes metadata that indicates how relational data is to be stored in the data store in a generic fashion not necessarily complying with the relational schema for the data. Next, the computer system stores data in the data store according to the generic relational data schema and stores metadata as data in the data store according to the generic relational meta-schema.

In another embodiment, a computer system instantiates a relational data abstraction layer that is configured to provide an interface to object-relational mappings (ORMs) in an ORM system that includes a data store, regardless of whether data is being retrieved from a real database or from other data sources that conform to a generic relational schema. The relational data abstraction layer is configured to hide the relational data's origin from the ORM system and support various connector components configured to load data from a variety of sources. The computer system receives a set of changes to metadata and accesses the received set of metadata changes, where the set of metadata changes indicates various data changes that are to be applied. The computer system also applies any data changes indicated by the set of metadata changes automatically without any user interaction or changes to the native schema of the data store.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions, computer program products and/or data structures. Such computer-readable media can be any available media that can be accessed by a general purpose or special purpose computer system. Computer-readable media that store computer-executable instructions are physical storage media including recordable-type storage media. Computer-readable media that carry computer-executable instructions are transmission media. Thus, by way of example, and not limitation, embodiments of the invention can comprise at least two distinctly different kinds of computer-readable media: physical storage media and transmission media.

Physical storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry or transport desired program code means in the form of computer-executable instructions or data structures and which can be accessed by a general purpose or special purpose computer. Combinations of the above should also be included within the scope of computer-readable media.

However, it should be understood, that upon reaching various computer system components, program code means in the form of computer-executable instructions or data structures can be transferred automatically from transmission media to physical storage media. For example, computer-executable instructions or data structures received over a network or data link can be buffered in RAM within a network interface card, and then eventually transferred to computer system RAM and/or to less volatile physical storage media at a computer system. Thus, it should be understood that physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

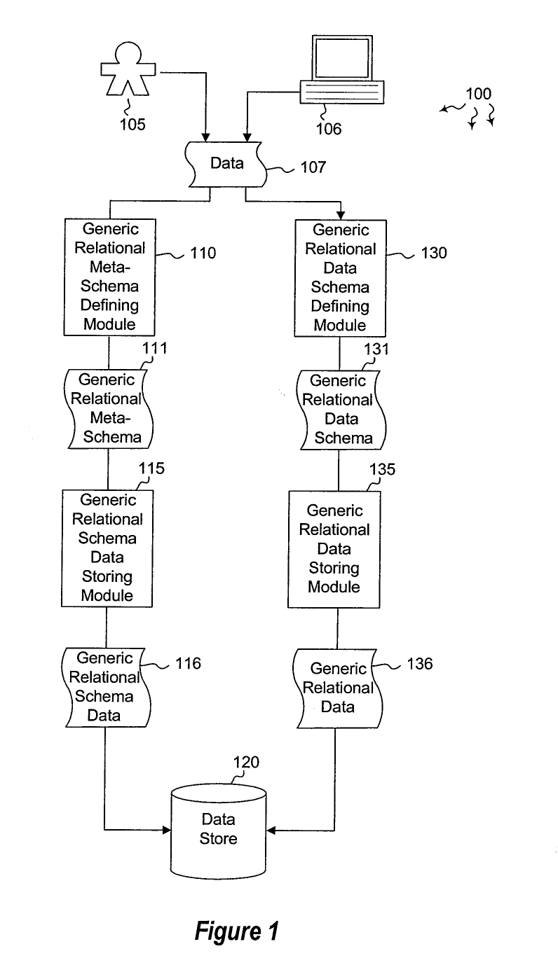

FIG. 1 illustrates a computer architecture 100 in which the principles of the present invention may be employed. Computer architecture 100 includes data store 120. Data store 120 may be any type of data storage system including a generic data store. Such a generic data store may be local or remote. In some cases, data store 120 may comprise a data store spread over a plurality of different storage devices such as in a storage area network (SAN). Data store 120 may be used to store relational and/or generic data that is accessible via various database or other data-driven software applications. As used herein, the terms generic data or generic relational data (GRD) refer to data that is accessible by other software applications without using a specific schema or data format. The generic data may be stored with corresponding metadata or generic relational schema data (GRSD), which indicates information about the data. This metadata/GRSD may also be stored as generic data.

As illustrated in FIG. 1, a user 105, a computer system 106, a software application, or some other data source may provide relational data 107 that is to be stored as generic data in data store 120. Various different schemas may be defined for the incoming relational data 107 including generic relational meta-schema 111 (defined by generic relational meta-schema defining module 110) and generic relational data schema 131 (defined by generic relational data schema defining module 130).

Generic relational meta-schema 111, as depicted in FIG. 1, may be configured to provide a pattern or style for structuring the metadata/GRSD in a generic manner. For example, the generic relational meta-schema may describe how the metadata/GRSD is to be structured as generic data so as to be accessible by other software applications, without using a specific schema or data format. Generic relational schema data storing module 115 may thus structure metadata/GRSD 116 according to the generic relational meta-schema 111 which was defined by module 110. The resulting GRSD 116 may then be stored in the data store 120 as generic data. It should be noted that because the GRSD is stored as generic data, changes to the GRSD do not require corresponding changes to the generic relational meta-schema (e.g. 111). Rather, these changes are made directly to the stored generic relational schema data.

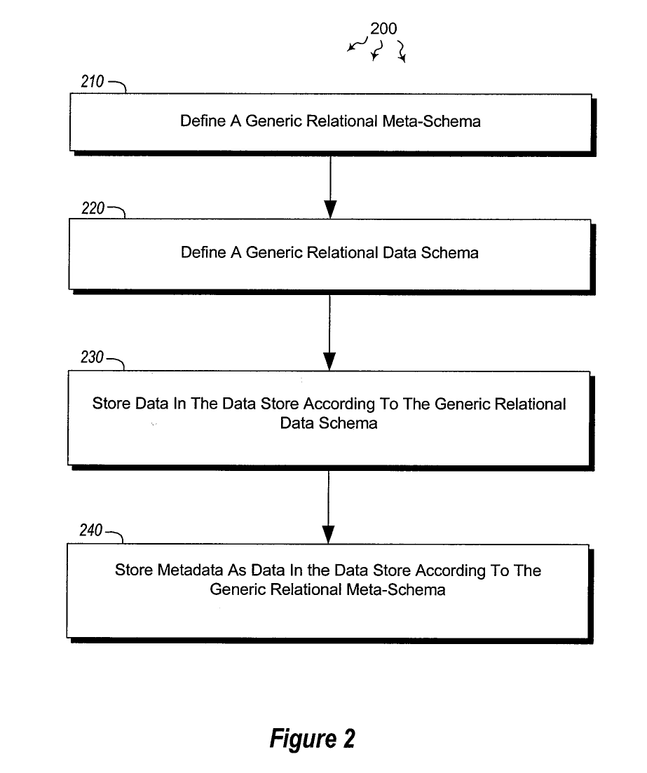

Similarly, generic relational data schema 131 may be configured to provide a pattern or style dictating how the relational data 107 is to be structured and stored in a generic manner. For example, the generic relational data schema 131 may state that a portion (or all) of the relational data is to be stored as generic data. In some cases, the generic relational data schema 131 may also specify various elements that are to be implemented when creating and/or storing the data to ensure that the data is stored in a generic manner. Using generic relational data schema 131, generic relational data storing module 135 may access relational data 107, structure the data according to the generic relational data schema 131 and send the structured generic relational data (GRD) 136 to the data store 120. These processes will be explained in greater detail below with regard to method 200 of FIG. 2.

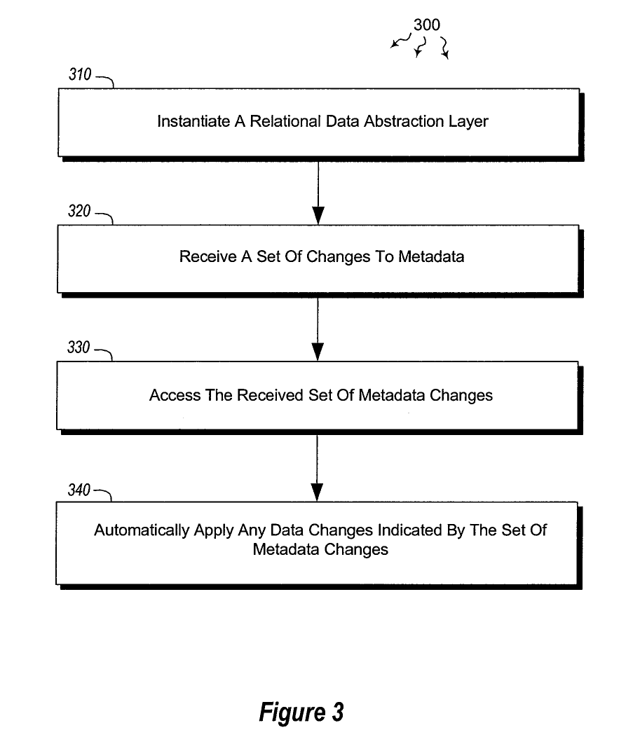

In view of the systems and architectures described above, methodologies that may be implemented in accordance with the disclosed subject matter will be better appreciated with reference to the flow charts of FIGS. 2 and 3. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 2 illustrates a flowchart of a method 200 for designing a computer implemented application in conjunction with a data store used by the computer application. The method 200 will now be described with frequent reference to the components and data of environment 100.

Method 200 includes an act of defining a generic relational meta-schema (GRMS), wherein the GRMS describes a generic representation for relational schemas, the GRMS comprising metadata indicating how a relational schema is to be stored as data in the data store (act 210). For example, generic relational meta-schema defining module 110 may define generic relational meta-schema (GRMS) 111, where GRMS 111 describes a generic representation for relational schemas (e.g. generic relational meta-schema 110). The GRMS may include metadata indicating how relational schema 110 is to be stored as data (e.g. generic relational schema data 116 (GRSD)) in data store 120. Generic relational meta-schema 111 thus allows metadata that corresponds to and provides information about generic relational data to be itself stored as generic data in the data store 120. Because the GRMS is stored as generic data, it can be stored in arbitrary places and in arbitrary formats and does not require the use of a relational database representing the schema.

In some cases, the data of data store 120 may be stored in various data records or data collections. These data records may comprise data fields which may be organized in columns and rows, in tabular form. Thus, these data records including the various data fields may be used to store the generic relational schema data 116 as well as generic relational data 136. The data records may include various tables for storing information including columns tables, types tables and field tables. These tables may be changed as the relational data 107 is changed. Data changes may be reflected in the data records by adding or removing columns, rows, data types and/or data fields within the data record.

Accordingly, in one example, a column may be added to (or removed from) a generic relational schema by adding (or removing) a row to/from a columns table and by adding a rows to a fields table such that one row is added to the fields table for each row of a type defined by GRDS 131. In another example, a new relational schema may be added to data store 120. This may be accomplished by adding rows to the schemas table, along with corresponding additional rows for types or columns of those new data types residing in the new schema. It should also be noted that, when changing data in a record, the appropriate, corresponding changes may be made to both the GRSD 116 and the GRD 136, such that each of the two stays in alignment with the other.

In some embodiments, a data's type designation may be changed by making the appropriate changes to the generic relational schema data 116. For instance, a data's type designation may be altered in the columns table of the generic relational schema data 116 by changing a value in a type column of a type field for a row in the columns table, so that the row represents the column metadata as data.

Method 200 also includes an act of defining a generic relational data schema (GRDS), wherein the GRDS describes a generic representation for relational data, the GRDS comprising metadata that indicates how relational data is to be stored in the data store in a generic fashion not necessarily complying with the relational schema for the data (act 220). For example, GRDS defining module 130 may define generic relational data schema 131, where schema 131 describes a generic representation for relational data (e.g. generic relational data 136 (GRD)). GRDS 131 includes metadata that indicates how relational data 136 is to be stored in data store 120 in a generic fashion not necessarily complying with the relational schema (e.g. GRMS 111) for the data. Thus, because the data is stored in a generic fashion, it can be used by other applications that may not be configured to access data stored according to the structure defined by GRMS 111.

As mentioned above, new data types may be added to GRD 136 by adding a new row to the types table and a new row to the columns table for each column of the new data type. Similarly, new data records may be added in corresponding data records tables and data fields tables. The data records may comprise various different portions of data and may be stored in any number of different data records tables and data fields tables, according to generic relational data schema 131 and/or generic relational meta-schema 111.

In some cases, new data types may be related to existing data types by adding a new foreign key column to the primary key of the existing data type. Thus, in cases where a user wants a new data type to be related to some existing data type, the user may add a new foreign key column to the existing primary key of the existing data type. In other cases, a user may relate one data type to another data type in a relational schema by changing a value in a key column of a row in the columns table corresponding to the first data type to refer to the primary key column or columns of the other data type. Moreover, a user may change constraints of a data type or a column in a relational schema by changing a value in a constraint column of a row in the types or columns table. These constraints on data types may comprise any type of constraint that would limit the permissible data types and may be changed by altering the data fields of the columns table in the generic relational data schema.

Method 200 includes an act of storing data in the data store according to the generic relational data schema (act 230). For example, data storing module 135 may store GRD 136 in data store 120 according to GRDS 131. The data may be stored as generic data. This generic data may be stored in arbitrary places and in arbitrary formats, according to user or system administrator settings. The user or administrator may also desire to add new generic relational data schemas may to the data store 120. These are similarly added as generic data. These added schemas may be used as the structure for other schematized (yet generic) data stored in data store 120.

Method 200 also includes an act of storing metadata as data in the data store according to the generic relational meta-schema (act 240). For example, generic relational schema data storing module 115 may store generic relational schema data 116 as data in data store 120 according to GRMS 111. As mentioned above, GRSD 116 may be stored in data store 120 as generic data. Moreover, any changes made to this generic data may be automatically converted (if necessary) to generic data.

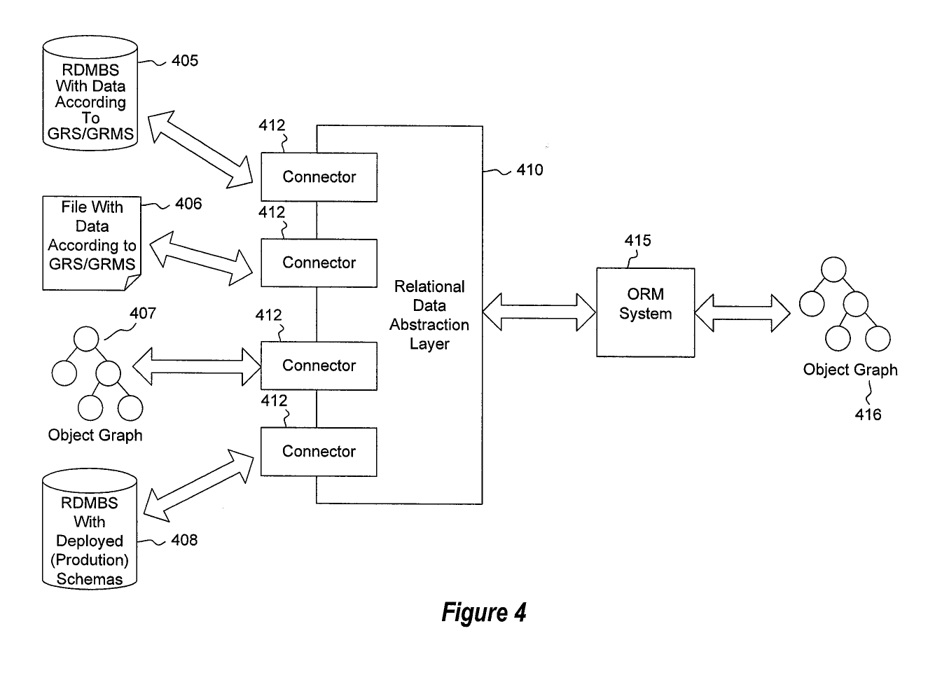

Additionally or alternatively, the conversion may include translating data between an application being developed and the data store 120. For such an application being developed, a generic relational data schema that is represented as data conforming to the GRMS may be stabilized and deployed to data store 120 as a native schema for the data store for use by the software application. In some cases, a user or software application will make changes to the application. These changes to the application or to the generic relational data schema may be applied while the application is running, without shutting down or recompiling the application. In some embodiments, a relational data abstraction layer may be implemented, as is explained more fully below with regard to FIG. 4 and method 300 of FIG. 3.

FIG. 3 illustrates a flowchart of a method 300 for automatically evolving a generic relational data schema corresponding to a software application during development of the application. The method 300 will now be described with frequent reference to the components and data of environment 100 and FIG. 4.

Method 300 includes an act of instantiating a relational data abstraction layer that is configured to provide an interface to object-relational mappings (ORMs) in an ORM system that includes an ORM data store, regardless of whether data is being retrieved from a real database or from other data sources that conform to a generic relational schema, wherein the relational data abstraction layer is configured to hide the relational data's origin from the ORM system and support various connector components configured to load data from a variety of sources (act 310). As used herein, the term object-relational mapping refers to mapping between different objects in an object-oriented programming language or mapping between different (incompatible) types in a relational database. An ORM system is a system that implements object-relational mappings.

For instance, a computer system may instantiate relational data abstraction layer 410. Layer 410 may be configured to provide an interface to ORMs in ORM system 415 regardless of whether data is being retrieved from a real database or from other data sources that conform to a generic relation schema (e.g. 131). Relational data abstraction layer 410 may also be configured to hide the relational data's origin from ORM system 415 and support various connector components 412 to load data from a variety of sources.

Connectors 412 may allow relational data abstraction layer 410 to load data from a relational database management system (RDBMS) 405, from a file (406) with data stored according to GRDS 131 or GRMS 111, from an object graph 407 (which may be different than or the same as object graph 416), and/or from an RDBMS with deployed (production) schemas 408. Many other connectors of varying types may be used in addition to or as an alternative to those listed above. In some embodiments, at least one of connectors 412 is connected to RDBMS 405. Similarly, in some embodiments, at least one of connector components 412 connects to data stored according to GRMS 111 or GRDS 131 in RDBMS 405. Furthermore, at least one of the connector components may be configured to load metadata and/or data from at least one of a file, a web service and an object graph.

Returning to FIG. 3, method 300 includes an act of receiving a set of changes to metadata (act 320). For example, relational data abstraction layer 410 may receive a set of changes to metadata from user 105, a file or another software application (106). The received set of metadata changes may indicate various changes that are to be applied to the data loaded by the relational data abstraction layer. For instance, the changes may include indications that certain rows or columns are to be added or removed within a schema. In some cases, these schema changes may be carried out solely by making changes to the underlying generic data. In other cases, heuristics may be applied to the data to make the data compliant with the schema changes. Thus, by applying these heuristics, the data may be changed so as to be read or otherwise accessed regardless of whether the schema for accessing the data has changed.

Method 300 also includes an act of the relational data abstraction layer accessing the received set of metadata changes, wherein the set of metadata changes indicates one or more data changes that are to be applied (act 330). For example, relational data abstraction layer 410 may access the received set of metadata changes and determine which changes are to be applied to the loaded data based on the information indicated in the metadata.

Method 300 includes an act of applying any data changes indicated by the set of metadata changes automatically without any user interaction or changes to the native schema of the ORM data store (act 340). For example, relational data abstraction layer 410 may apply any data changes indicated by the received set of metadata changes automatically without any user interaction or changes to the native schema of the ORM data store. Because the GRSD and the GRD are stored as generic data, changes may be applied without user interaction. Moreover, the changes may be applied by changing the generic data; these changes can be performed without changing the generic relational meta-schema or the generic relational data schema. Accordingly, schema evolution (or changing the schema to match changes in an application) can be carried out solely by making changes to the underlying generic data.

In some embodiments, these automatic changes may be performed at runtime, while the corresponding application is running. This may be beneficial in scenarios involving rapid application deployment and/or where small prototypes are continually generated. Because the relational data and relational metadata has been converted to generic data, the use of a relational database can be avoided and changes can be quickly and automatically applied.

The present invention may also be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. In a computing environment, a method for designing a computer implemented application in conjunction with a data store used by the computer application, the method comprising:
an act of defining a generic relational meta-schema (GRMS), wherein the GRMS describes a generic representation for relational schemas, the GRMS comprising metadata indicating how a relational schema is to be stored as data in the data store;
an act of defining a generic relational data schema (GRDS), wherein the GRDS describes a generic representation for relational data, the GRDS comprising metadata that indicates how relational data is to be stored in the data store in a generic fashion not necessarily complying with the relational schema for the data;
an act of storing data in the data store according to the generic relational data schema; and
an act of storing metadata as data in the data store according to the generic relational meta-schema.

2. The method of claim 1, further comprising an act of adding a column to a generic relational schema by adding a row to a columns table and by adding rows to a fields table such that one row is added to the fields table for each row of the type defined by the generic relational data schema.

3. The method of claim 1, further comprising changing a type of a column in a relational schema by changing a value in a type column of a row in the columns table, such that the row represents the column metadata as data.

4. The method of claim 1, further comprising an act of adding one or more new data types to a relational schema by adding a new row to the types table and a new row to the columns table for each column of the new data type.

5. The method of claim 4, further comprising an act of adding one or more new rows in corresponding records and fields tables.

6. The method of claim 1 further comprising an act of relating one data type to another data type in a relational schema by changing a value in a key column of a row in the columns table corresponding to the first data type to refer to the primary key column or columns of the other data type.

7. The method of claim 1 further comprising an act of changing one or more constraints of a data type or a column in a relational schema by changing a value in a constraint column of a row in the types or columns table.

8. The method of claim 1, further comprising an act of adding a new relational schema to the data store as generic data, wherein the adding includes adding one or more rows to the schemas table, along with corresponding rows for types or columns of those new data types residing in the new schema.

9. The method of claim 1, further comprising an act of removing one or more data types from a relational schema by removing the relevant row from the types table and one or more rows from the columns table for each column of the data type.

10. The method of claim 1, further comprising an act of removing one or more rows by removing corresponding rows from the records and fields tables.

11. The method of claim 1, further comprising an act of translating data between the application being developed and the data store.

12. The method of claim 1, wherein schema updates are carried out by updating the corresponding generic schema data in the data store.

13. The method of claim 1, further comprising an act of deploying a relational schema that is represented as data conforming to the generic relational meta-schema to a data store as a native schema for the data store for use by a software application.

14. The method of claim 1, further comprising an act of making one or more changes to the application and the relational schema while the application is running, without shutting down or recompiling the application.

15. A computer program product for implementing a method for automatically evolving a generic relational data schema corresponding to a software application during development of the application, without using a relational database representing the schema, the computer program product comprising one or more computer-readable storage media having stored thereon computer-executable instructions that, when executed by one or more processors of the computing system, cause the computing system to perform the method, the method comprising:
an act of instantiating a relational data abstraction layer that is configured to provide an interface to object-relational mappings (ORMs) in an ORM system that includes a data store, regardless of whether data is being retrieved from a real database or from other data sources that conform to a generic relational schema, wherein the relational data abstraction layer is configured to hide the relational data's origin from the ORM system and support various connector components configured to load data from a variety of sources;
an act of receiving a set of changes to metadata;
an act of the relational data abstraction layer accessing the received set of metadata changes, wherein the set of metadata changes indicates one or more data changes that are to be applied; and
an act of applying any data changes indicated by the set of metadata changes automatically without any user interaction or changes to the native schema of the data store.

16. The computer program product of claim 15, wherein at least one connector component connects to an actual relational database management system.

17. The computer program product of claim 15, wherein at least one connector component connects to data stored according to the generic relational meta-schema and generic relational schema in a relational database management system.

18. The computer program product of claim 17, wherein schema evolution is carried out solely by applying data changes.

19. The computer program product of claim 15, wherein at least one of the connector components is configured to load metadata and data from at least one of a file, a web service or an object graph.

20. A computer system comprising the following:
one or more processors;
system memory;
one or more computer-readable storage media having stored thereon computer-executable instructions that, when executed by the one or more processors, causes the computing system to perform a method for designing a computer implemented application in conjunction with a data store used by the computer application, the method comprising the following:
an act of defining a generic relational meta-schema (GRMS), wherein the GRMS describes a generic representation for relational schemas, the GRMS comprising metadata indicating how a relational schema is to be stored as data in the data store;
an act of defining a generic relational data schema (GRDS), wherein the GRDS describes a generic representation for relational data, the GRDS comprising metadata that indicates how relational data is to be stored in the data store in a generic fashion not necessarily complying with the relational schema for the data;
an act of storing data in the data store according to the generic relational data schema; and
an act of storing metadata as data in the data store according to the generic relational meta-schema.
